(19) United States
(12) Patent Application Publication
(10) Pub. No.: US 2026/0027528 A1
(43) Pub. Date: Jan. 29, 2026

(54) BATCH-PROCESS GAS MIXER

(71) Applicant: Re:Build Manufacturing, LLC, Framingham, MA (US)

(72) Inventor: Nicholas Lauder, Medford, MA (US)

(21) Appl. No.: 19/283,479

(22) Filed: Jul. 29, 2025

Related U.S. Application Data
(60) Provisional application No. 63/676,698, filed on Jul. 29, 2024.

(51) Int. Cl. B01F 23/10; B01F 35/21; B01F 35/22; B01F 35/221; B01F 35/71; B01F 35/83

(52) U.S. Cl. CPC B01F 23/19; B01F 35/2113; B01F 35/2132; B01F 35/2202; B01F 35/2213; B01F 35/71805; B01F 35/833

(57) ABSTRACT

A batch-process gas mixer may be provided by a mixing vessel, connected to first and second gas sources via respective first and second valve-operated lines; a first pressure sensor, configured to measure a first pressure in the mixing vessel; a mixed gas reservoir, connected to the mixing vessel via a third valve-operated line; a second pressure sensor, configured to measure a second pressure in the mixed gas reservoir; and a controller, configured to operate the first, second, and third valve-operated lines to: mix a first gas with a second gas according to the first pressure in the mixing vessel to produce a mixed gas with a predefined ratio of the first and second gases, and store the mixed gas in the mixed gas reservoir at the predefined ratio according to the first pressure in the mixing vessel and the second pressure in the mixed gas reservoir.

### BACKGROUND

The present disclosure claims priority to U.S. Provisional Patent Application 63/676,698, filed on 2024 Jul. 29, titled “BATCH-PROCESS GAS MIXER”, which is incorporated herein in its entirety.

### BACKGROUND

A number of commercially available devices exist that mix two or more gases using mass flow controllers to blend gases at continuous flowrates. Accurately controlling a wide range of flowrates with mass flow controllers to achieve a blended gas of a desired composition with an even composition (e.g., the same blend at various times and locations) is difficult and expensive, particularly when related to small quantities of the blended gas. One option is to exhaust some of the mixed gas to maintain higher flows, but this is wasteful. Another option is to pulse the flows into a reservoir, but the transients associated with the flow control systems can introduce gas concentration errors.

### SUMMARY

The present disclosure provides a batch-process gas mixer system and method of control thereof. The system mixes gas using low-cost components in discreet batches and stores the mixed gas downstream in a reservoir that can be used to supply working gas to downstream consumers of the mixed gas, such as electronic regulators. The present system is highly scalable with little impact on cost. Additional gasses can be added easily by including an additional valve per gas. Higher flowrates can be achieved by expanding the reservoir volumes and increasing the air pump size without compromising the lower limit of the gas use (for which there is none).

The approach described herein is may be particularly useful for consumers that that operate generally at extremely low flows (e.g., <=1 microliters per minute (μL/min)) with occasional demands many orders of magnitude higher, such as pressure-drive organ-on-a-chip systems.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates external facings of an example batched gas mixing system, according to embodiments of the present disclosure.

FIG. 2 illustrates an example plumbing diagram for a batched gas mixing system. according to embodiments of the present disclosure.

FIGS. 3A and 3B illustrate an example plumbing diagram for a batched gas mixing system, according to embodiments of the present disclosure.

FIGS. 4A-4C illustrate example batched gas mixers, according to embodiments of the present disclosure.

FIG. 5 is a flowchart for an example method of batched gas mixing, according to embodiments of the present disclosure.

FIG. 6 illustrates a computing device, according to embodiments of the present disclosure.

### DETAILED DESCRIPTION

The present disclosure provides a batched-process gas mixer system and method of control thereof. The system mixes gas using low-cost components in discreet batches and stores the mixed gas downstream in a reservoir that can be used to supply working gas to downstream consumers of the mixed gas, such as electronic regulators. The present system is highly scalable with little impact on cost. Additional gasses can be added easily by including an additional valve-operated line per gas. Higher flowrates can be achieved by expanding the reservoir volumes and increasing the air pump size without compromising the lower limit of the gas use (for which there is none).

Unlike systems that use expensive mass flow controllers in continuous or intermittent balanced flow, the presently described system blends gases in batches using pressure-swings to measure and control the addition of gases to a mixing reservoir. Gases are dispensed individually into the mixing reservoir using inexpensive solenoid valves while pressure is monitored. The pressure increase during each addition determines the final concentration. An algorithm compensates for the thermodynamic effects of work done to the gas by allowing for settling time. Any error between target pressure and actual pressure can be offset in a subsequent batch, allowing for batches to sequentially adjust and optimize the mix of the stored gas. After a batch is mixed, another solenoid valve allows the mixture to flow into and equilibrate with a downstream reservoir, which is used to supply the demands of electronic pressure regulators while the next batch is being mixed in the mixing vessel.

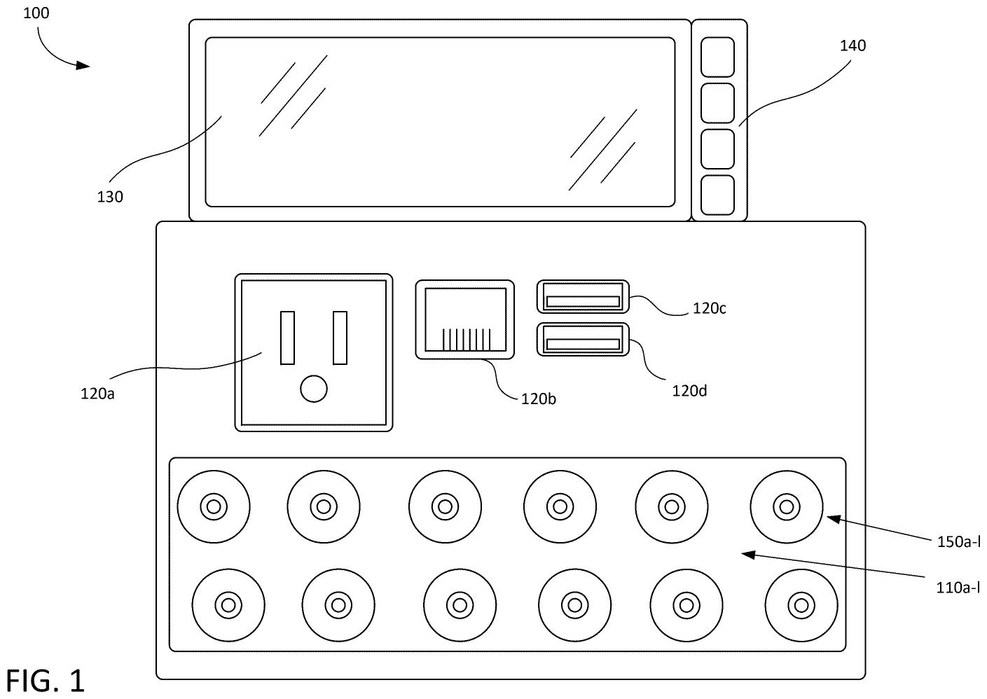

FIG. 1 illustrates external facings of an example batched gas mixing system 100, according to embodiments of the present disclosure.

The batched gas mixing system 100 provides an external gas interfaces 110a-1 (generally or collectively, gas interface 110 or ports 110) for various supply devices and consuming devices to provide raw gases to or received a mixed gas from the batched gas mixing system 100. In various embodiments, the gas interfaces 110 may include adapter for connecting external devices (e.g., gas sources, gas-consuming devices, tubing) or may be orifices without adapters (e.g., for the intake of ambient air, the venting of gasses internal to the batched gas mixing system 100 to the ambient environment). In various embodiments, the gas interfaces 110 are separated from the internal tubing and plumbing of the system 100 and the other internal components via one or more membrane filters 150a-l (generally or collectively, membrane filters 150), which may be single membrane filter 150 shared by all or some (e.g., two or more) of the gas interfaces 110 or an individual membrane filter 150 for a given gas interface 110, and one or more of the gas interfaces 110 may be unassociated with a membrane filter 150.

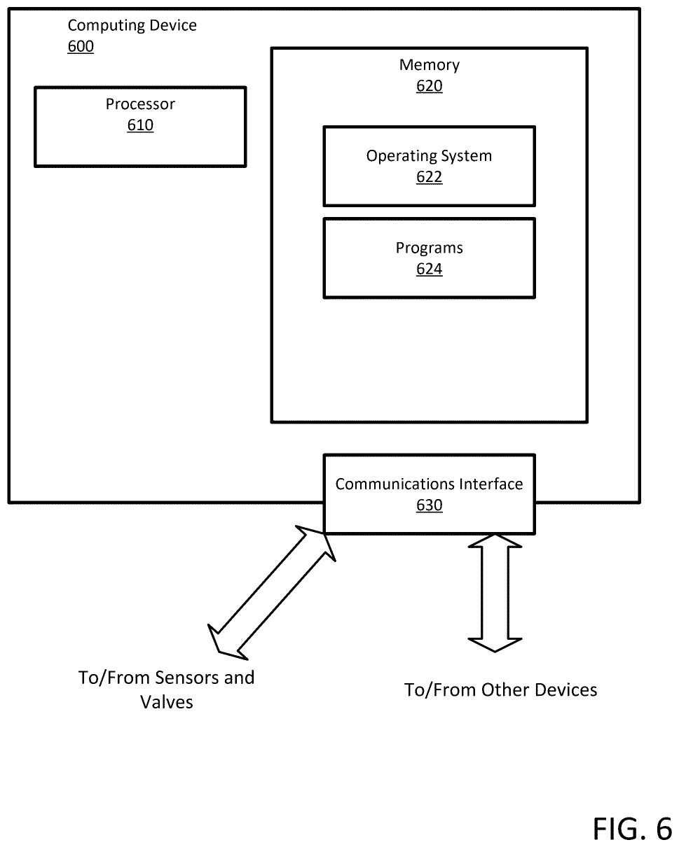

Additionally, the batched gas mixing system 100 provides one or more electronic interfaces 120a-d (generally or collectively, electronic interfaces 120) for receiving power and communicating with external computing devices or memory storage devices, which may include power sockets, USB ports, category-5 networking ports, etc. Such electronic interfaces 120 may interface with a computing device (such as the computing device 600 discussed in relation to FIG. 6).

The batched gas mixing system 100 may include or be in communication with an output device, such as a touch screen or display unit that outputs current statuses of the batch gas mixing system 100, allows a user to specify various ratios of gases to mix together, and otherwise control the system 100. Additionally, various hardware interfaces 140 (e.g., buttons, toggles, switches) may be included to control operation of the system 100.

The present disclosure contemplates that the system 100 may take various form factors beyond those shown in the present example, and may include more or fewer of the various interfaces discussed herein in different arrangements and conforming to different standards. In various embodiments, the system 100 is provided for benchtop use, and generally generates batches of the mixed gas with a volume less than 10 liters (L).

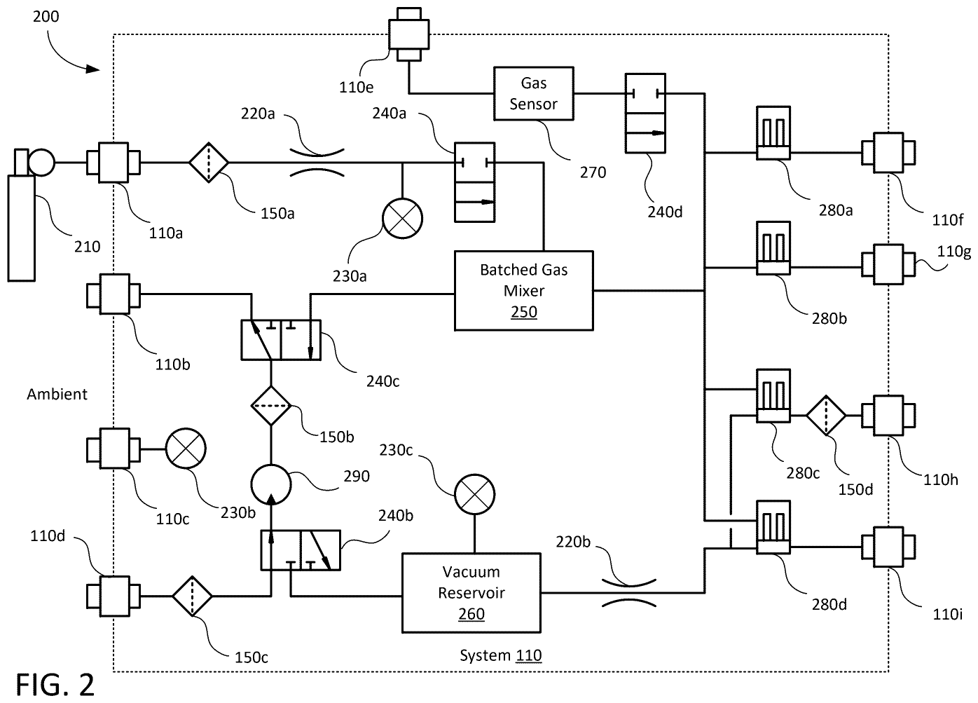

FIG. 2 illustrates an example plumbing diagram 200 for a batched gas mixing system 100, according to embodiments of the present disclosure.

One or more gas supplies 210 are connected via respective ports 110a (and via membrane filters 150a) to a batched gas mixer 250 on a valve controlled input line. The input line may include a flow restrictor 220a, and includes a pressure sensors 230a and a valve 240a (e.g., a solenoid valve) that selectively connects or disconnects the gas supply 210 to the mixer 250. Although only one input line is illustrated in FIG. 2, the present disclosure contemplates that the multiples instances of the input line and gas supply 210 may be provided to allow for multiple different gases (or backup for one gas) to be provided to the batched gas mixer 250.

In some embodiments, an air pump 290 is selectively connectable between the ambient environment (e.g., via a port 110d and respective membrane filter 150c) and the batched gas mixer 250 to provide ambient air as one of the constituent gases to mix in the batched gas mixer 250. Additionally or alternatively, the air pump 290 is selectively connectable between the ambient environment (e.g., via a port 110b and optional membrane filter 150b) and a vacuum reservoir 260 to draw vacuum for later use (e.g., pulling gases from the vacuum reservoir 260 into the ambient environment). A first valve 240b may selectively connect an intake end of the air pump 290 to the ambient air intake line (e.g., the port 110d) or to the vacuum reservoir 260. Similarly, a second valve 240c may selectively connect an outflow end of the air pump 290 to the ambient air outflow line (e.g., the port 110b) or to the batched gas mixer 250.

A pressure sensor 230b is illustrated as connected to a port 110c to measure the air pressure of the ambient environment, which may be used to regulate the air pump 290.

As illustrated, various electric pressure regulators 280a-d (generally or collectively, pressure regulators 280) are connected with the output of the batched gas mixer 250 and the vacuum reservoir 260 on respective input ends and to various output ports 110f-i (and may include respective membrane filters 150d disposed therebetween) to supply the mixed gas from the batched gas mixer 250 and/or vacuum to various gas consuming devices connected to respective output ports 110 at a desired pressure (positive or negative). In various embodiments, a flow restrictor 220b is included on an output end of the vacuum reservoir 260 connected to the various regulators 280. Having more than one regulator 280 capable of both pressure and vacuum allows the operation of fluidic devices above or below ambient pressure.

A gas sensor 270 is selectively connectable (e.g., via a valve 240d, such as a solenoid valve) to the output from the batched gas mixer 250 to measure a concentration of a given constituent gas in the mixed gas. In various embodiments, the gas sensor 270 is connected to a vent port 110e to vent the sampled mixed gas to an ambient environment or to connect a negative pressure source to draw the mixed gas from the batched gas mixer 250 through the gas sensor 270. Although only one gas sensor 270 is illustrated, in FIG. 2, the present disclosure contemplates that multiple instances of the gas sensing line and gas sensor 270 may be provided, or multiple gas sensors 270 may be provided on a single gas sensing line to detect the relative concentrations of different constituent gases in the mixed gas. As will be appreciated, for a mixed gas that includes N constituent gases, no more than N−1 different gas sensors 270 may be required, as the concentration of the N^{th} gas may be inferred by knowing the concentration of the other gases.

The gas sensor 270 may monitor the relative concentration of one or more of the constituent gases to adjust a ratio of the gases in the next batch to generate to stabilize the mixed gas concentrations to remain in a predefined window. For example, when a gas sensor 270 determines that a first batch, intended to have a blend of 50±2% gas A with 50±2% gas B actually has a mixture of 60% gas A and 40% gas B, the determination may be used to generate a second batch (to combine with a remainder of the first batch) with a blend of 40% gas A and 60% gas B to bring the overall mixture to be back within the window of 50±2% for each gas.

In some embodiments, gas sensor 270 is provided to merely monitor a concentration of a given gas, and the output thereof is not used to control or adjust the concentration of the gas (e.g., per the closed-loop control examples given herein). Because the system can be run in open loop control, merely monitoring the gas concentration dramatically simplifies the control system and increases reliability, particularly when the error in actual gas concentration is lower than the error in the ability to sense the concentration.

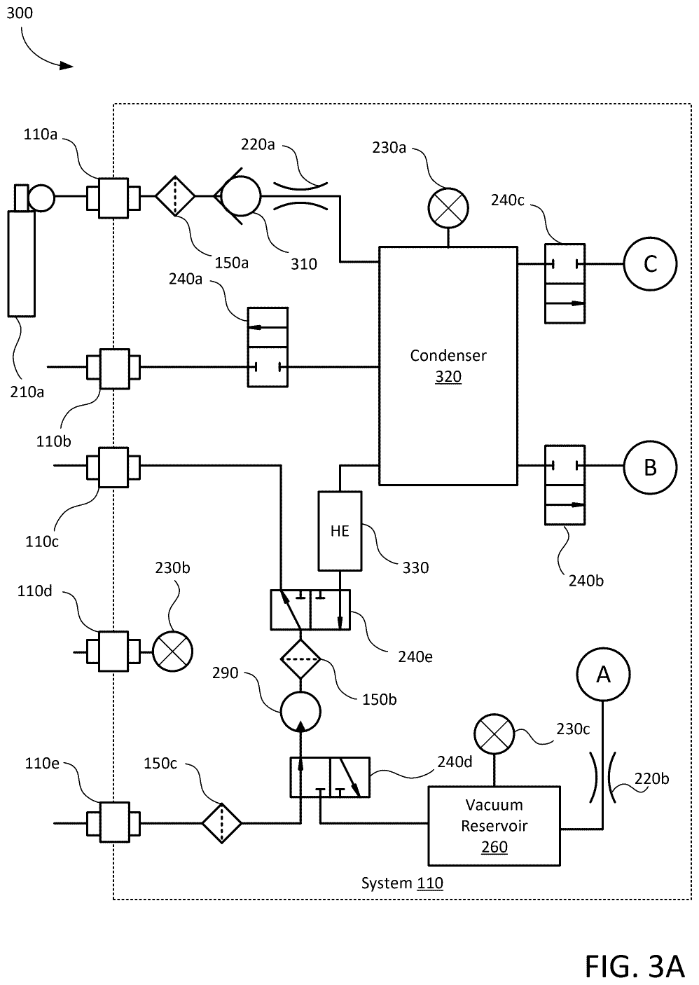

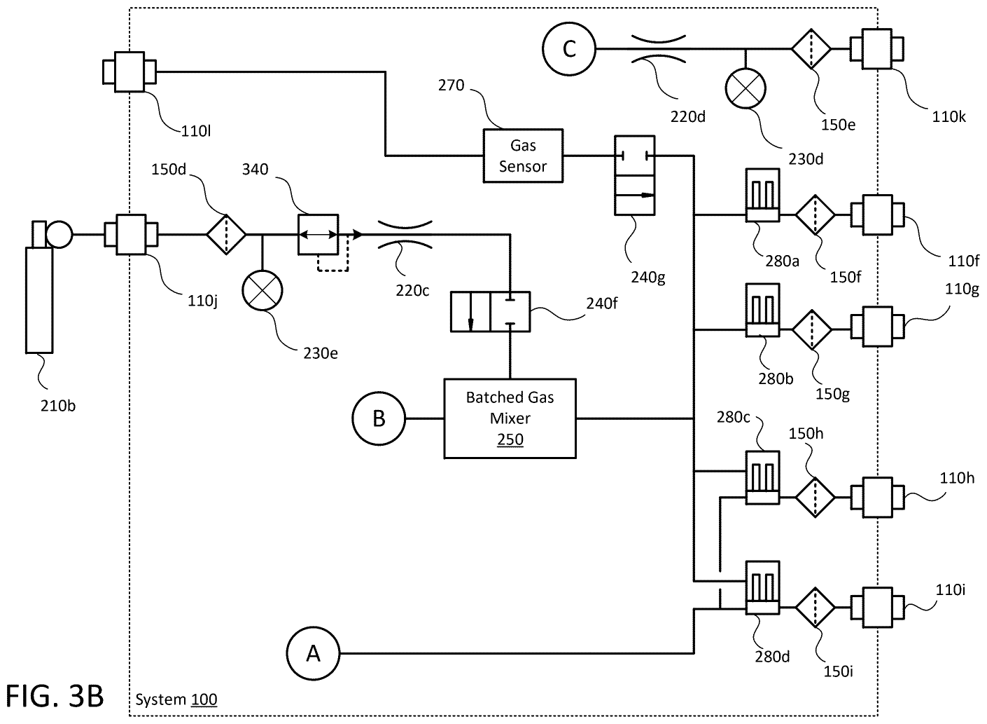

FIGS. 3A and 3B illustrate an example plumbing diagram 300a-b (split over two sheet) for a batched gas mixing system 100, according to embodiments of the present disclosure.

As shown in FIG. 3A, an air pump 290 is selectively connectable between the ambient environment (e.g., via a port 110e and respective membrane filter 150c) and a condenser vessel 320 to provide ambient air as one of the constituent gases to mix in the batched gas mixer 250 via supply line including a second valve 240b (e.g., a solenoid valve), linked via reference B to the batched gas mixer shown in FIG. 3B. Additionally or alternatively, the air pump 290 is selectively connectable between the ambient environment (e.g., via a port 110c and optional membrane filter 150b) and a vacuum reservoir 260 to draw vacuum for later use (e.g., pulling gases from the vacuum reservoir 260 into the ambient environment). A fourth valve 240d may selectively connect an intake end of the air pump 290 to the ambient air intake line (e.g., the port 110e) or to the vacuum reservoir 260. Similarly, a fifth valve 240e may selectively connect an outflow end of the air pump 290 to the ambient air outflow line (e.g., the port 110c) or to the condenser vessel 320.

In various embodiments, a heat exchanger 330 is disposed between the fifth valve 240e and the condenser vessel 320 to encourage condensation of humidity from the ambient air collected in the condenser vessel 320, which is collected and drained periodically from the condenser vessel 320 via a drain line that includes first valve 240a (e.g., a solenoid valve) that selectively connects the condenser vessel 320 to a drain port 110b.

The condenser vessel 320 may act as an ambient air supply, to selectively provide (dehumidified and filtered) ambient air to the batched gas mixer 250 shown in FIG. 3B via the supply line linked via reference B between FIGS. 3A and 3B according to the control of the second valve 240b. Additionally or alternatively, the ambient air or other collected gases may be vented via the vent line lined via reference C between FIGS. 3A and 3B according to the control of the third valve 240c. The vent line, as shown in FIG. 3B may include a flow restrictor 220d, a pressure second 230d and a membrane filter 150e in the flow path to a vent port 110k to monitor and control an amount of gas released from the condenser vessel 320.

In addition or alternatively to accepting ambient air, the condenser vessel 320 may receive pressurized gases from a gas supply 210a via a checked supply line. The checked supply line runs between an input port 110a (which may include a membrane filter 150a and a flow restrictor 220a) and an input end of the condenser vessel 320 that is connected or disconnected via a check valve 310. The check valve 310 permits flow of gas from the gas supply 210 to the condenser vessel 320 when the pressure in the gas supply 210 exceeds the pressure in the condenser vessel 320. For example, the gas supply 210a may provide a mix of gases substantially equivalent to ambient air at a desired pressure such that when the pump 290 is inactive, or being used to draw vacuum in the vacuum reservoir 260, the condenser vessel 320 may still be supplied with an air-like mixture of gases for use by the batched gas mixer 250, or as the humidity is being drained from the condenser vessel 320, the pump 290 and gas supply 210 can cooperatively maintain a desired pressure in the condenser vessel 320.

The condenser vessel 320 includes a pressure sensor 230a to monitor an amount of gas held therein and to signal the pump 290 to activate or deactivate.

A pressure sensor 230b is illustrated as connected to a port 110d to measure the air pressure of the ambient environment, which may be used to regulate the air pump 290.

As shown in FIG. 3B, one or more gas supplies 210b are connected via respective ports 110j (and via membrane filters 150d) to a batched gas mixer 250 on a valve controlled input line. The input line may include a flow restrictor 220c and a flow regulator 340, and includes a pressure sensor 230e and a valve 240f (e.g., a solenoid valve) that selectively connects or disconnects the gas supply 210b to the mixer 250. Although only one input line is illustrated in FIGS. 3A-3B, the present disclosure contemplates that the multiple instances of the input line and gas supply 210b may be provided to allow for multiple different gases (or backup for one gas) to be provided to the batched gas mixer 250.

As illustrated, various electric pressure regulators 280a-d (generally or collectively, pressure regulators 280) are connected with the output of the batched gas mixer 250 and the vacuum reservoir 260 (e.g., via reference A to FIG. 3A) on respective input ends and to various output ports 110f-i (and may include respective membrane filters 150f-i disposed therebetween) to supply the mixed gas from the batched gas mixer 250 and/or vacuum to various gas consuming devices connected to respective output ports 110 at a desired pressure (positive or negative). In various embodiments, a flow restrictor 220b is included on an output end of the vacuum reservoir 260 connected to the various regulators 280. Having more than one regulator 280 capable of both pressure and vacuum allows the operation of fluidic devices above or below ambient pressure.

A gas sensor 270 is selectively connectable (e.g., via a valve 240g, such as a solenoid valve) to the output from the batched gas mixer 250 to measure a concentration of a given constituent gas in the mixed gas. In various embodiments, the gas sensor 270 is connected to a vent port 110l to vent the sampled mixed gas to an ambient environment or to connect a negative pressure source to draw the mixed gas from the batched gas mixer 250 through the gas sensor 270. Although only one gas sensor 270 is illustrated, in FIG. 3B, the present disclosure contemplates that multiple instances of the gas sensing line and gas sensor 270 may be provided, or multiple gas sensors 270 may be provided on a single gas sensing line to detect the relative concentrations of different constituent gases in the mixed gas. As will be appreciated, for a mixed gas that includes N constituent gases, no more than N−1 different gas sensors 270 may be required, as the concentration of the N^{th} gas may be inferred by knowing the concentration of the other gases.

The gas sensor 270 may monitor the relative concentration of one or more of the constituent gases to adjust a ratio of the gases in the next batch to generate to stabilize the mixed gas concentrations to remain in a predefined window. For example, when a gas sensor 270 determines that a first batch, intended to have a blend of 50±2% gas A with 50±2% gas B actually has a mixture of 60% gas A and 40% gas B, the determination may be used to generate a second batch (to combine with a remainder of the first batch) with a blend of 40% gas A and 60% gas B to bring the overall mixture to be back within the window of 50±2% for each gas.

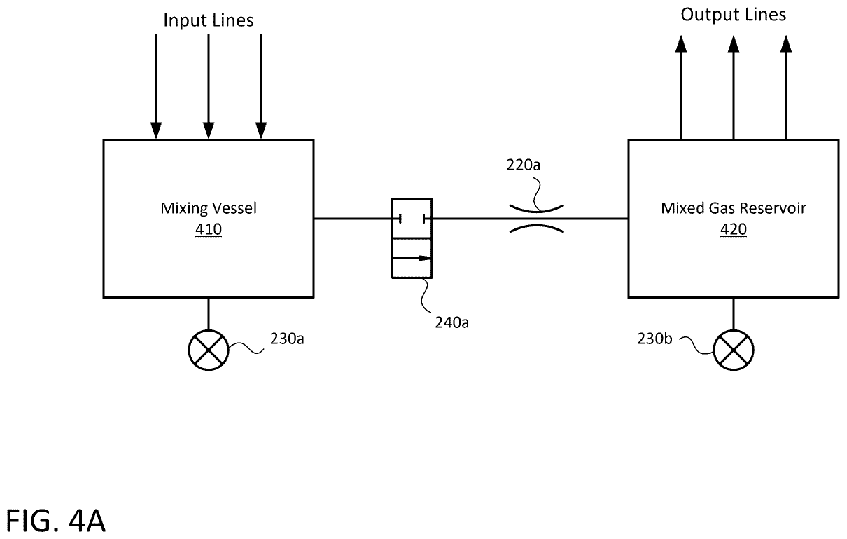

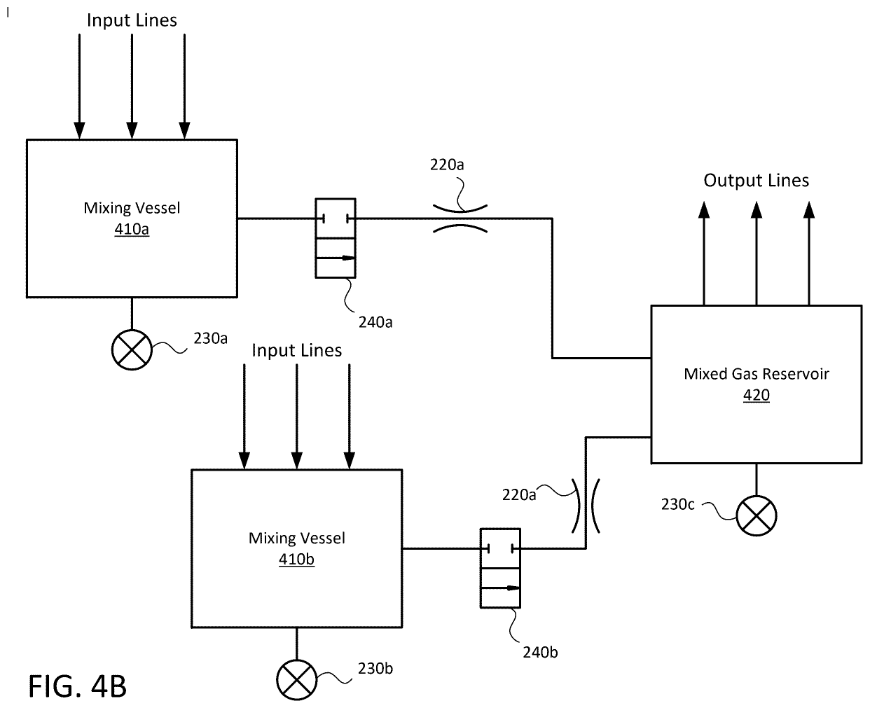

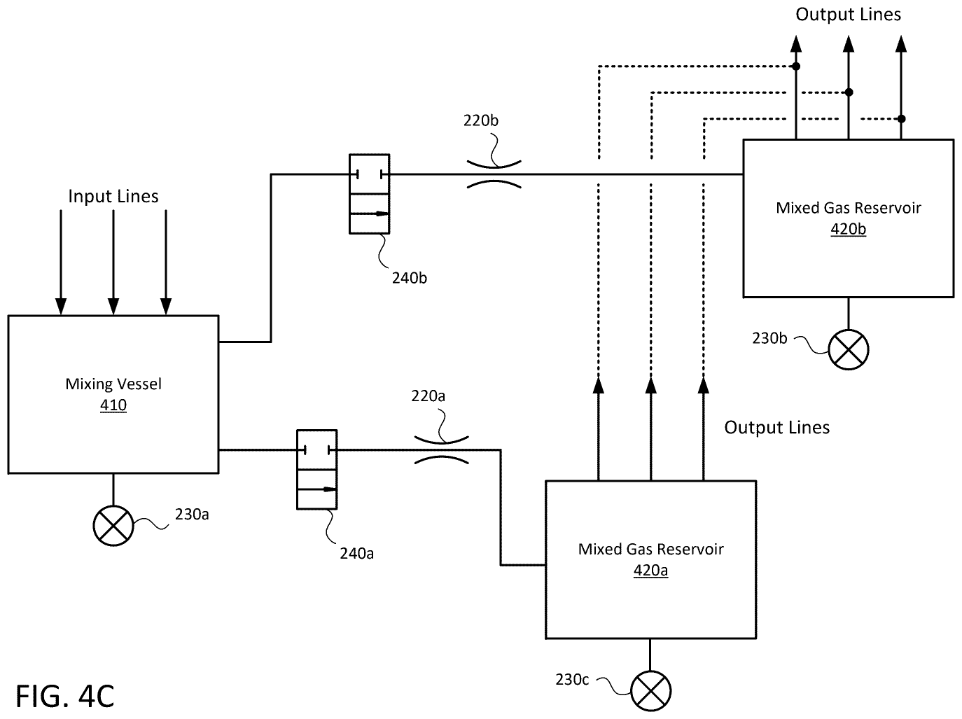

FIGS. 4A-4C illustrate examples of batched gas mixers 250, according to embodiments of the present disclosure. The batched gas mixer 250 may be understood as a batched gas mixing means having at least two chambers, each of which is selectively connectable to a plurality of external gas lines, either to gas sources or gas consumers, and selectively connectable to each other.

The first chamber is the mixing vessel 410, which may be provided as a single vessel (as in FIGS. 4A and 4C) or with multiple instances of mixing vessels 410a-b (as in FIG. 4B). Each mixing vessel 410 may be connected to two or more input lines, which may be valve controlled lines to supply various constituent gases to mix together in a predefined ratio. Each mixing vessel 410 is associated with one or more pressure sensors 230 (or a first pressure sensor 230a for a first mixing vessel 410a and a second pressure sensor 230b for a second mixing vessel 410b) that are used to determine how much of a given gas has been supplied to the mixing vessel 410 to track the concentration of the gases supplied during a given batch mixing process.

As shown in FIG. 4B, multiple mixing vessels 410a-b may be selectively connectable to one mixed gas reservoir 420. Depending on the demand for the mixed gas, multiple batches may be assembled in parallel in the different mixing vessels 410a-b with the same or different concentrations of the constituent gases.

The second chamber is the mixed gas reservoir 420, which may be provided as a single reservoir (as in FIGS. 4A and 4B) or with multiple instances of mixing vessels 420a-b (as in FIG. 4C). Each mixed gas reservoir 420 may be connected to one or more output lines, which may be valve controlled lines to supply the mixed gas to various gas consuming devices. The mixed gas reservoirs 420 may be loaded with gas at a desired ration from the mixing vessels 410 while simultaneously providing the mixed gas to downstream consumers, and may deliver at an asynchronous rate relative to how the gas is loaded therein. For example, a mixed gas reservoir 420 may be configured to provide an output of the mixed gas at a first flow rate over 0 and up to 500 milliliters per minute (mL/min), and be periodically refilled at a different flowrate in one or more batches of freshly mixed gases.

Each mixing vessel 410 is associated with one or more pressure sensors 230 (or a first pressure sensor 230c for a first mixed gas reservoir 420a and a second pressure sensor 230b for a second m mixed gas reservoir 420b) that are used to determine how much of the mixed gas is contained in the respective mixed gas reservoir 420 and to determine, when connected to a mixing vessel 410, whether the gases in the two connected chambers have been transferred (e.g., by detecting an equalized pressure in the two chambers, in conjunction with the pressure sensor 230 in the mixing vessel 410, a decreasing pressure from the pressure sensor 230 in the mixing vessel 410, etc.). In various embodiments, the output lines from one mixed gas reservoir 420a may be separate from or combined/shared with the output lines from a second mixed gas reservoir 420b. In various embodiments, the pressure sensors 230 in the mixed gas reservoirs 260 are used to ensure that, even when transferring gas from the mixing vessels 410, that sufficient volume of gas is available for downstream devices.

A respective gas transfer line is defined between each pair of chamber types-between each mixing vessel 410 and each mixed gas reservoir 420. The gas transfer line include corresponding valve 240 (e.g., a solenoid valve) and (optionally) a respective flow restrictor 220.

In some embodiments, a given downstream device at any given time is connected to no more than one upstream device for gas transfer. For example, a first mixing vessel 410a should not be simultaneously connected for gas transfer to both a first mixed gas reservoir 420a and a second mixed gas reservoir 420b, nor should a first gas supply 210a and a second gas supply 210b be simultaneously connected the first mixing vessel 410a. In contrast, a first gas supply 210a may be connected for gas transfer to a first mixing vessel 410a simultaneously as a second gas supply 210b is connected for gas transfer to a second mixing vessel 410b. Similarly, a first mixing vessel 410a may be connected for gas transfer to a first mixed gas reservoir 420a simultaneously as a second mixing vessel 410b is connected for gas transfer to a second mixed gas reservoir 420

In various embodiments, a mixing vessel 410 has a substantially equivalent internal volumes as a mixed gas reservoir 420; however, the mixing vessel 410 may be larger than the mixed gas reservoir 420 or vice versa in various embodiments. For example, the chambers may each contain about 0.5, 1, 2, 5, or 10 L of gas, when configured to benchtop use, but may be sized smaller or larger depending on gas demand from the gas consumers and the number of mixing vessels 410 and mixed gas reservoirs 420 included in the system. In some As will also be appreciated, although generally considered to be downstream of the mixing vessel 410 in a given batched gas mixer 250, the mixed gas reservoir 420 may be used as a gas supply 210 for a mixing vessel in a downstream batched gas mixer 250.

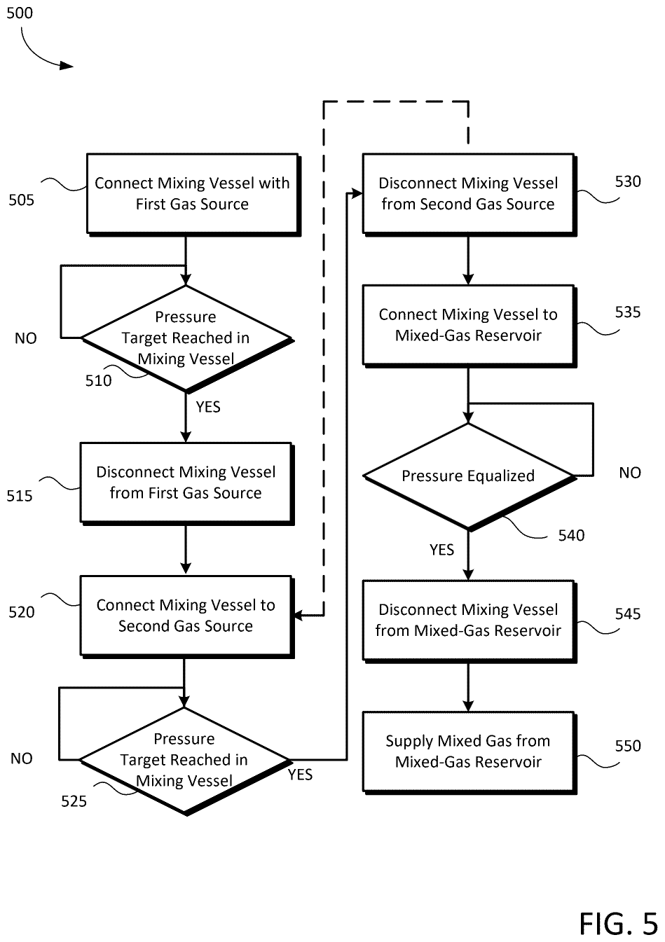

FIG. 5 is a flowchart for an example method 500 of batched gas mixing, according to embodiments of the present disclosure.

At block 505, the system connects the mixing vessel with a first gas source. In various embodiments, a solenoid valve in a valve-operated line between the mixing vessel and the first gas source is opened

At block 510, the system determines whether the pressure in the mixing vessel has reached a first target pressure.

At block 515, the system disconnects the mixing vessel from the first gas source. In various embodiments, a solenoid valve in a valve-operated line between the mixing vessel and the first gas source is closed

At block 520, the system connects the mixing vessel to a second (or subsequent) gas source. In various embodiments, a solenoid valve in a valve-operated line between the mixing vessel and the second (or subsequent) gas source is opened.

At block 525, the system determines whether the pressure in the mixing vessel has reached a second (or subsequent) target pressure.

At block 530, the system disconnects the mixing vessel from the second (or subsequent) gas source. In various embodiments, a solenoid valve in a valve-operated line between the mixing vessel and the second (or subsequent) gas source is closed. In various embodiments, method 500 may proceed to block 535 from block 530 in response to a pressure reading in the mixed-gas reservoir falling below a replenishment threshold. In embodiments that mix three or more gases in a batch produced in the mixing vessel, method 500 may return to block 520 from block 530 for a subsequent gas source to be connected via an associated valve-operated line to the mixing vessel.

At block 535, the system connect the mixing vessel to the mixed-gas reservoir. In various embodiments, a solenoid valve in a valve-operated line between the mixing vessel and the mixed-gas reservoir is opened.

At block 540, the system determines whether the pressures in the mixing vessel and in the mixed-gas reservoir have equalized or have reached an equilibrium range. In various embodiments, pressure sensors in each of the mixing vessel and mixed-gas reservoir may be checked to determine that the pressure reading in each chamber is substantially equal and remain substantially equal for a predefined amount of time (to avoid transients in gas transfer) to determine whether the chambers have equalized pressure. In various embodiments, the mixing vessel is pressurized at a higher pressure than the mixed gas reservoir, and an equalization of pressure between the chambers or an increase in pressure in the reservoir may be used to gauge that the gas transfer has succeeded.

At block 545, the system disconnects the mixing vessel from the mixed-gas reservoir. In various embodiments, a solenoid valve in a valve-operated line between the mixing vessel and the mixed-gas reservoir is closed.

At block 550, the system supplies the mixed gas from the mixed-gas reservoir to one or more downstream consumers for the mixed gas. In various embodiments, one or more electronic pressure regulator provide the mixed-gas at a desired pressure from the mixed-gas reservoir at various pressures. Block 550 may be performed while a next batch of mixed gas is prepared according to blocks 505-530, and the output of the mixed gas from the reservoir may be monitored to adjust the target pressure for the constituent gases to reach in block 510 and block 525 to rectify any imbalances in the gas mixture from a target range.

FIG. 6 illustrates a computing device 600, as may be used to control a batch-process gas mixer, according to embodiments of the present disclosure. The computing device 600 may include at least one processor 610, a memory 620, and a communication interface 630.

The processor 610 may be any processing unit capable of performing the operations and procedures described in the present disclosure. In various embodiments, the processor 610 can represent a single processor, multiple processors, a processor with multiple cores, and combinations thereof.

The memory 620 is an apparatus that may be either volatile or non-volatile memory and may include RAM, flash, cache, disk drives, and other computer readable memory storage devices. Although shown as a single entity, the memory 620 may be divided into different memory storage elements such as RAM and one or more hard disk drives. As used herein, the memory 620 is an example of a device that includes computer-readable storage media, and is not to be interpreted as transmission media or signals per se.

As shown, the memory 620 includes various instructions that are executable by the processor 610 to provide an operating system 622 to manage various features of the computing device 600 and one or more programs 624 to provide various functionalities to users of the computing device 600, which include one or more of the features and functionalities described in the present disclosure. One of ordinary skill in the relevant art will recognize that different approaches can be taken in selecting or designing a program 624 to perform the operations described herein, including choice of programming language, the operating system 622 used by the computing device 600, and the architecture of the processor 610 and memory 620. Accordingly, the person of ordinary skill in the relevant art will be able to select or design an appropriate program 624 based on the details provided in the present disclosure.

In various embodiments, the memory 620 stores various gas blend recipes to draw relative concentration of two or more gases from respective sources to produce desired blends of the mixed gas for consumption by various gas consuming devices. In various embodiments, two recipes may produce the same blend using sources that provide different initial concentrations for the constituent gases. Additionally, the memory 620 may store data or instructions for a compensation algorithm 628 to compensate for thermodynamic effects on gas composition in a mixing vessel as more gas is added to the vessel and the pressure increases and work done by the gas that may affect settling or mixing time.

The communication interface 630 facilitates communications between the computing device 600 and other devices, which may also be computing devices as described in relation to FIG. 6. In various embodiments, the communication interface 630 includes antennas for wireless communications and various wired communication ports. The computing device 600 may also include or be in communication, via the communication interface 630, one or more input devices (e.g., a keyboard, mouse, pen, touch input device, etc.) and one or more output devices (e.g., a display, speakers, a printer, etc.). The devices that the communications interface may be in communication with include any of the sensors, valves, and associated hydraulic, pneumatic, or motor systems used to actuate the valves.

Although not explicitly shown in FIG. 6, it should be recognized that the computing device 600 may be connected to one or more public and/or private networks via appropriate network connections via the communication interface 630. It will also be recognized that software instructions may also be loaded into a non-transitory computer readable medium, such as the memory 620, from an appropriate storage medium or via wired or wireless means.

Accordingly, the computing device 600 is an example of a system that includes a processor 610 and a memory 620 that includes instructions that (when executed by the processor 610) perform various embodiments of the present disclosure. Similarly, the memory 620 is an apparatus that includes instructions that, when executed by a processor 610, perform various embodiments of the present disclosure.

In addition to the embodiments described above, many examples of specific combinations are within the scope of the disclosure, some of which are detailed below:

Clause 1: A system, comprising: a mixing vessel, connected to a first gas source via a first valve-operated line and connected to a second gas source via a second valve-operated line; a first pressure sensor, configured to measure a first pressure in the mixing vessel; a mixed gas reservoir, connected to the mixing vessel via a third valve-operated line; a second pressure sensor, configured to measure a second pressure in the mixed gas reservoir; and a controller, configured to operate the first valve-operated line, the second valve-operated line, and the third valve-operated line to: mix a first gas from the first gas source with a second gas from the second gas source according to the first pressure in the mixing vessel to produce a mixed gas with a predefined ratio of the first gas to the second gas, and store the mixed gas in the mixed gas reservoir at the predefined ratio according to the first pressure in the mixing vessel and the second pressure in the mixed gas reservoir.

Clause 2: The system of any of clauses 1-8, wherein a volume of the gas mixing vessel is substantially equal to a volume of the mixed gas reservoir.

Clause 3: The system of any of clauses 1-8, wherein the mixing vessel is connected to a third gas source via a fourth valve-operated line.

Clause 4: The system of any of clauses 1-8, wherein the second gas source comprises: an air pump having an inflow connected to an ambient environment; a condenser vessel connected on an intake side to an outflow of the air pump and on an outtake side to the second valve-operated line.

Clause 5: The system of any of clauses 1-8, wherein a heat exchanger is disposed between the air pump and the condenser vessel.

Clause 6: The system of any of clauses 1-8, further comprising: a vacuum reservoir selectively connectable to the inflow via a solenoid valve that connects the inflow to the ambient environment in a first state and to the vacuum reservoir in a second state.

Clause 7: The system of any of clauses 1-8, further comprising: a gas sensor connected to an output line of the mixed gas reservoir, configured to determine a first concentration of the second gas in the mixed gas currently held in the mixed gas reservoir to adjust a second concentration of the second gas in a subsequent batch to introduce into the mixed gas reservoir to maintain a desired concentration within a predefined window in the mixed gas reservoir.

Clause 8: The system of any of clauses 1-8, further comprising an output line connected to the mixed gas reservoir, selectively connectable to a plurality of downstream gas delivery ports.

Clause 9: A method, comprising: connecting a mixing vessel with a first gas supply for a first gas; in response to detecting a first pressure in the mixing vessel, disconnecting the mixing vessel from the first gas supply; in response to disconnecting the mixing vessel from the first gas supply, connecting the mixing vessel with a second gas supply for a second gas; in response to detecting a second pressure in the mixing vessel, disconnecting the mixing vessel from the second gas supply; in response to disconnecting the mixing vessel from the second gas supply, connecting the mixing vessel to a mixed gas reservoir; in response to a third pressure in the mixing vessel equaling a fourth pressure in the mixed gas reservoir, disconnecting the mixing vessel from the mixed gas reservoir; and supplying a mixture of the first gas and the second gas from the mixed gas reservoir at a predefined ratio, wherein the predefined ratio is controlled by the first pressure and the second pressure.

Clause 10: The method of any of clauses 9-13, further comprising: in response to disconnecting the mixing vessel from the second gas supply, connecting the mixing vessel with a third gas supply for a third gas; and in response to detecting a third pressure in the mixing vessel, disconnecting the mixing vessel from the third gas supply.

Clause 11: The method of any of clauses 9-13, further comprising, in response to determining that a first gas blend in the mixed gas reservoir fall outside of a target range for component gases thereof: sequentially reconnecting the first gas supply and the second gas supply to the mixing vessel to produce a second gas blend that when combined with the first gas blend results in a third gas blend inside of the target range.

Clause 12: The method of any of clauses 9-13, wherein the second gas supply is ambient air and connecting the mixing vessel to the second gas supply includes: pumping the ambient air to a desired pressure; condensing the ambient air at the desired pressure; and venting moisture from the ambient air at the desired pressure back to an ambient environment.

Clause 13: The method of any of clauses 9-13, further comprising: providing a first output of the mixture at a first flow rate of between 0.5-10 microliters per minute (μL/min) for a first time period; and providing a second output of the mixture at a second flow rate of between 500-5000 μL/min for a second time period, shorter than the first time period.

Clause 14: A system, comprising: a batched gas mixing means, selectively connectable to a first gas source and selectively connectable to a second gas source; a first pressure sensor, configured to measure a first pressure in a first chamber of the batched gas mixing means; a second pressure sensor, configured to measure a second pressure in a second chamber of the batched gas mixing means, selectively connectable to the first chamber; and a controller, configured to selectively connect or disconnect the first gas source, the second gas source, and the second chamber with the first chamber to: mix a first gas from the first gas source with a second gas from the second gas source according to the first pressure in the first chamber to produce a mixed gas with a predefined ratio of the first gas to the second gas, and store the mixed gas in the second chamber at the predefined ratio according to the first pressure in the first chamber and the second pressure in the second chamber.

Clause 15: The system of any of clauses 14-20, further comprising a gas sensor, connected to an output from the second chamber, configured to detect a first concentration of the second gas in the mixed gas that is output from the second chamber to adjust a second concentration of the second gas in a subsequent batch mixed in the first chamber to introduce into the second chamber to maintain a desired concentration of the second gas within a predefined window in the second chamber.

Clause 16: The system of any of clauses 14-20, wherein the first chamber has a substantially equal volume to the second chamber.

Clause 17: The system of any of clauses 14-20, wherein to store the mixed gas in the second chamber at the predefined ratio according to the first pressure in the first chamber and the second pressure in the second chamber, the controller is configured to: disconnect the first chamber from the first gas source and the second gas source; connect the first chamber with the second chamber, thereby permitting flow of gas between the first chamber and the second chamber; and disconnect the first chamber from the second chamber once pressure equalizes between the first chamber and the second chamber.

Clause 18: The system of any of clauses 14-20, The system of claim 14, wherein the second chamber is configured to provide an output of the mixed gas at a first flow rate between 0.5-500 microliters per minute (μL/min) and at a second flow rate between 500-5000 mL/min.

Clause 19: The system of any of clauses 14-20, wherein connecting the second gas source to the first chamber includes: pumping ambient air to a condenser vessel at a desired pressure; and removing humidity from the ambient air in the condenser vessel.

Clause 20: The system of any of clauses 14-20, wherein the controller operates at least three solenoid valves to selectively connect or disconnect the first gas source, the second gas source, and the second chamber with the first chamber.

Certain terms are used throughout the description and claims to refer to particular features or components. As one skilled in the art will appreciate, different persons may refer to the same feature or component by different names. This document does not intend to distinguish between components or features that differ in name but not function.

As used herein, the term “optimize” and variations thereof, is used in a sense understood by data scientists to refer to actions taken for continual improvement of a system relative to a goal. An optimized value will be understood to represent “near-best” value for a given reward framework, which may oscillate around a local maximum or a global maximum for a “best” value or set of values, which may change as the goal changes or as input conditions change. Accordingly, an optimal solution for a first goal at a given time may be suboptimal for a second goal at that time or suboptimal for the first goal at a later time.

As used herein, the terms “upstream” and “downstream” are used in the sense of relative directions of a flow path, with elements referred as “upstream” being closer to a source than elements referred to as “downstream”, and elements referred as “downstream” being closer to a destination than elements referred to as “upstream”. Consider the example where element A provides output to element B, and element B provides output to element C. In the present example, both element A and element B may be referred to as “upstream” from element C, and both element B and element C may be referred to as “downstream” from element A, but relative to element B, element A (and not element C) would be considered “upstream” from element B and element C (and not element A) would be considered “downstream” from element B.

As used herein, various chemical compounds are referred to by associated element abbreviations set by the International Union of Pure and Applied Chemistry (IUPAC), which one of ordinary skill in the relevant art will be familiar with. Similarly, various units of measure may be used herein, which are referred to by associated short forms as set by the International System of Units (SI), which one of ordinary skill in the relevant art will be familiar with.

As used herein, “about,” “approximately” and “substantially” are understood to refer to numbers in a range of the referenced number, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole numbers, or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in the present disclosure, a phrase referring to “at least one of” a list of items refers to any set of those items, including sets with a single member, and every potential combination thereof. For example, when referencing “at least one of A, B, or C” or “at least one of A, B, and C”, the phrase is intended to cover the sets of: A, B, C, A-B, B-C, A-C, and A-B-C, where the sets may include one or multiple instances of a given member (e.g., A-A, A-A-A, A-A-B, A-A-B-B-C-C-C, etc.) and any ordering thereof. For avoidance of doubt, the phrase “at least one of A, B, and C” shall not be interpreted to mean “at least one of A, at least one of B, and at least one of C”.

As used in the present disclosure, the term “determining” encompasses a variety of actions that may include calculating, computing, processing, deriving, investigating, looking up (e.g., via a table, database, or other data structure), ascertaining, receiving (e.g., receiving information), accessing (e.g., accessing data in a memory), retrieving, resolving, selecting, choosing, establishing, and the like.

Without further elaboration, it is believed that one skilled in the art can use the preceding description to use the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

Within the claims, reference to an element in the singular is not intended to mean “one and only one” unless specifically stated as such, but rather as “one or more” or “at least one”. Unless specifically stated otherwise, the term “some” refers to one or more. No claim element is to be construed under the provision of 35 U.S.C. § 112(f) unless the element is expressly recited using the phrase “means for” or “step for”. All structural and functional equivalents to the elements of the various embodiments described in the present disclosure that are known or come later to be known to those of ordinary skill in the relevant art are expressly incorporated herein by reference and are intended to be encompassed by the claims. Moreover, nothing disclosed in the present disclosure is intended to be dedicated to the public regardless of whether such disclosure is explicitly recited in the claims.

The invention is claimed as follows:

1. A system, comprising:
a mixing vessel, connected to a first gas source via a first valve-operated line and connected to a second gas source via a second valve-operated line;
a first pressure sensor, configured to measure a first pressure in the mixing vessel;
a mixed gas reservoir, connected to the mixing vessel via a third valve-operated line; and
a controller, configured to operate the first valve-operated line, the second valve-operated line, and the third valve-operated line to:
mix a first gas from the first gas source with a second gas from the second gas source according to the first pressure in the mixing vessel to produce a mixed gas with a predefined ratio of the first gas to the second gas, and
store the mixed gas in the mixed gas reservoir at the predefined ratio.

2. The system of claim 1, wherein a volume of the gas mixing vessel is substantially equal to a volume of the mixed gas reservoir.

3. The system of claim 1, wherein the mixing vessel is connected to a third gas source via a fourth valve-operated line.

4. The system of claim 1, wherein the second gas source comprises:
an air pump having an inflow connected to an ambient environment; and
a condenser vessel connected on an intake side to an outflow of the air pump and on an outtake side to the second valve-operated line.

5. The system of claim 4, wherein a heat exchanger is disposed between the air pump and the condenser vessel.

6. The system of claim 4, further comprising:
a vacuum reservoir selectively connectable to the inflow via a solenoid valve that connects the inflow to the ambient environment in a first state and to the vacuum reservoir in a second state.

7. The system of claim 1, further comprising:
a gas sensor connected to an output line of the mixed gas reservoir, configured to determine a first concentration of the second gas in the mixed gas currently held in the mixed gas reservoir to adjust a second concentration of the second gas in a subsequent batch to introduce into the mixed gas reservoir to maintain a desired concentration within a predefined window in the mixed gas reservoir.

8. The system of claim 1, further comprising an output line connected to the mixed gas reservoir, selectively connectable to a plurality of downstream gas delivery ports.

9. A method, comprising:
connecting a mixing vessel with a first gas supply for a first gas;
in response to detecting a first pressure in the mixing vessel, disconnecting the mixing vessel from the first gas supply;
in response to disconnecting the mixing vessel from the first gas supply, connecting the mixing vessel with a second gas supply for a second gas;
in response to detecting a second pressure in the mixing vessel, disconnecting the mixing vessel from the second gas supply;
in response to disconnecting the mixing vessel from the second gas supply, connecting the mixing vessel to a mixed gas reservoir;
in response to a third pressure in the mixing vessel equaling a fourth pressure in the mixed gas reservoir, disconnecting the mixing vessel from the mixed gas reservoir; and
supplying a mixture of the first gas and the second gas from the mixed gas reservoir at a predefined ratio.

10. The method of claim 9, further comprising:
in response to disconnecting the mixing vessel from the second gas supply, connecting the mixing vessel with a third gas supply for a third gas; and
in response to detecting a third pressure in the mixing vessel, disconnecting the mixing vessel from the third gas supply.

11. The method of claim 9, in response to determining that a first gas blend in the mixed gas reservoir fall outside of a target range for component gases thereof:
sequentially reconnecting the first gas supply and the second gas supply to the mixing vessel to produce a second gas blend that when combined with the first gas blend results in a third gas blend inside of the target range.

12. The method of claim 9, wherein the second gas supply is ambient air and connecting the mixing vessel to the second gas supply includes:
pumping the ambient air to a desired pressure;
condensing the ambient air at the desired pressure; and
venting moisture from the ambient air at the desired pressure back to an ambient environment.

13. The method of claim 10, further comprising:
providing an output of the mixture at a flow rate of over 0 and up to 500 milliliters per minute (mL/min).

14. A system, comprising:
a batched gas mixing means, selectively connectable to a first gas source and selectively connectable to a second gas source;
a first pressure sensor, configured to measure a first pressure in a first chamber of the batched gas mixing means; and
a controller, configured to selectively connect or disconnect the first gas source, the second gas source, and the second chamber with the first chamber to:
mix a first gas from the first gas source with a second gas from the second gas source according to the first pressure in the first chamber to produce a mixed gas with a predefined ratio of the first gas to the second gas, and
store the mixed gas in the second chamber at the predefined ratio.

15. The system of claim 14, further comprising a gas sensor, connected to an output from the second chamber, configured to detect a first concentration of the second gas in the mixed gas that is output from the second chamber to adjust a second concentration of the second gas in a subsequent batch mixed in the first chamber to introduce into the second chamber to maintain a desired concentration of the second gas within a predefined window in the second chamber.

16. The system of claim 14, wherein the first chamber has a substantially equal volume to the second chamber.

17. The system of claim 14, wherein to store the mixed gas in the second chamber, the controller is configured to:
disconnect the first chamber from the first gas source and the second gas source;
connect the first chamber with the second chamber, thereby permitting flow of gas between the first chamber and the second chamber; and
disconnect the first chamber from the second chamber once pressure equalizes between the first chamber and the second chamber.

18. The system of claim 14, wherein the second chamber is configured to provide an output of the mixed gas at a first flow rate over 0 and up to 500 milliliters per minute (mL/min).

19. The system of claim 14, wherein connecting the second gas source to the first chamber includes:
pumping ambient air to a condenser vessel at a desired pressure; and
removing humidity from the ambient air in the condenser vessel.

20. The system of claim 14, wherein the controller operates at least three solenoid valves to selectively connect or disconnect the first gas source, the second gas source, and the second chamber with the first chamber.
